(19) United States
(12) Patent Application Publication
(10) Pub. No.: US 2001/0020693 A1
(43) Pub. Date: Sep. 13, 2001

(54) Cylinder head unit with roll-type rotary slide valve

(76) Inventors: Ulrich Bischofberger, Esslingen (DE); Reiner Ulrich, Weissach (DE)

Correspondence Address: COLLARD & ROE, P.C., 1077 Northern Boulevard, Roslyn, NY, 11576-1696, US

(21) Appl. No.: 09/800,768

(22) Filed: Mar. 7, 2001

(30) Foreign Application Priority Data
Mar. 7, 2000 (DE) 100 11 154.8

(51) Int. Cl. F16K 51/00

(52) U.S. Cl. 251/368

(57) ABSTRACT

A roll-type rotary slide valve having good running properties for a cylinder head unit of a piston-controlled internal combustion engine. For this purpose, the roll-type rotary slide valve is made of austenitic cast iron.

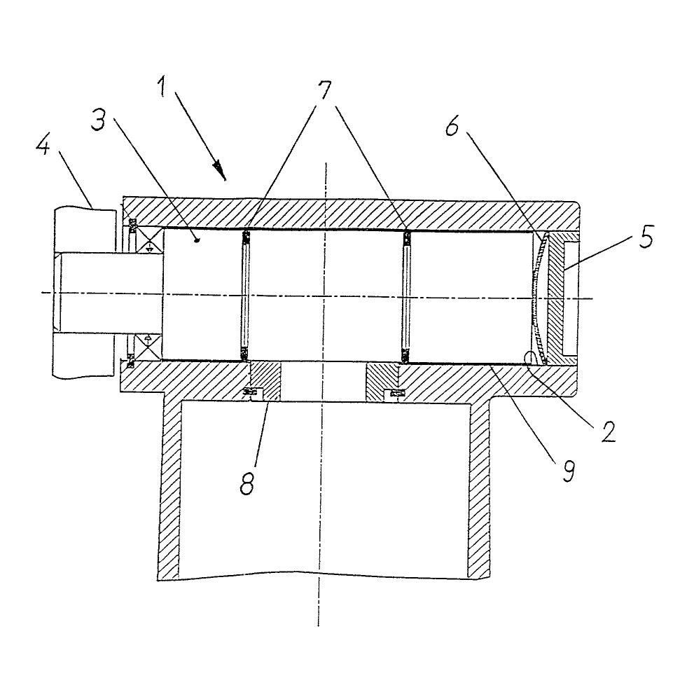

### BACKGROUND OF THE INVENTION

1. Field of the Invention

The invention relates to a cylinder head unit with at least one roll-type rotary slide valve for controlling the gas change of a piston-type internal combustion engine. The slide valve is rotatably arranged in a bore. Roll-type rotary slide valves represent an alternative to conventional valve controls for piston-type internal combustion engines that operate with lifting valves.

2. The Prior Art

Cylinder head units with roll-type rotary slide valves are known, for example from PCT Publication WO94/24240, and French Patent 25 53 469. Composite materials based on carbon or ceramics, hardened steel grades and bronze are specified in French Patent 25 53 469 as possible materials for such a roll-type rotary slide valve.

### SUMMARY OF THE INVENTION

The present invention provides another suitable material for roll-type rotary slide valves.

The present invention comprises a cylinder head unit with at least one roll-type rotary slide valve rotatably arranged in a bore for controlling the gas change of a piston-type internal combustion engine, in which the roll-type rotary slide valve consists of austenitic cast iron.

The bore is at least partially coated within the area of the running surface for the roll-type rotary slide valve. The coating is a nickel coating with dispersed hard particles or a hard chrome coating.

There is at least one carbon sealing ring arranged in the cylinder head unit. This carbon sealing ring is in sliding contact with the roll-type rotary slide valve and seals the gap between the roll-type rotary slide valve and the housing of the valve within the zone of the gas flow openings.

Austenitic cast iron has become known under the trade name NiResist. The roll-type rotary slide valve made of austenitic cast iron as defined by the invention has good running properties, especially in the presence of lubrication deficiency. Particularly good running properties are obtained in combination with hard chrome or nickel dispersion coatings.

The austenitic cast iron preferably has the following composition: 3% C max, 1 to 5.5% Si, 7% Mn max, 12 to 22% Ni, 1 to 5.5% Cr, 5 to 8% Cu. The graphite is present in the lamellar or spherical form.

### BRIEF DESCRIPTION OF THE DRAWINGS

Other objects and features of the present invention will become apparent from the following detailed description considered in connection with the accompanying drawing. It is to be understood, however, that the drawing is designed as an illustration only and not as a definition of the limits of the invention.

The FIGURE shows a cylinder head unit with a roll-type rotary slide valve as defined by the invention.

### DETAILED DESCRIPTION OF THE PREFERRED EMBODIMENT

The FIGURE shows a roll-type rotary slide valve 3 arranged in a bore 2 in a cylinder head 1 made of aluminum alloy. Rotary slide valve 3 controls the gas change and is made of NiResist. The channels conducting the gas in roll-type rotary slide valve 3 are not shown in the drawing.

Roll-type rotary slide valve 3 is driven via a belt pulley 4. Bore 2 is sealed on one side with an aluminum cover 5, which is pressed into the bore. A run-up disk 6 made of plastic is arranged between roll-type rotary slide valve 3 and the cover 5 for damping vibrations.

Two piston rings are arranged with an offset joint in each of the two grooves 7 on the periphery of the roll for sealing the gas-conducting channels. The transition between the roll and the combustion chamber is sealed by a sealing ring 8 made of carbon. Sealing ring 8 is in sliding contact with roll 3 and is initially tensioned by a spring.

Within the area of its running surface, bore 2 is provided with a hard chrome coating 9.

Accordingly, while only a single embodiment of the present invention has been shown and described, it is obvious that many changes and modifications may be made thereunto without departing from the spirit and scope of the invention.

What is claimed is:

1. A cylinder head unit comprising:
at least one roll-type rotary slide valve rotatably arranged in a bore for controlling gas change of a piston-type internal combustion engine, said valve consisting of austenitic cast iron.

2. The cylinder head unit according to claim 1, wherein a running surface of the bore is at least partially coated.

3. The cylinder head unit according to claim 2, wherein the coating is selected from the group consisting of a nickel coating with dispersed hard particles and a hard chrome coating.

4. The cylinder head unit according to claim 1, further comprising at least one carbon sealing ring arranged in the cylinder head unit, said carbon sealing ring being in sliding contact with the roll-type rotary slide valve and sealing a gap between the roll-type rotary slide valve and a housing of the valve within an area of gas flow openings.
